(19) United States
(12) Patent Application Publication
(10) Pub. No.: US 2015/0228212 A1
(43) Pub. Date: Aug. 13, 2015

(54) Posted Sign

(71) Applicant: Timothy C. Bejian, Rome, NY (US)

(72) Inventor: Timothy C. Bejian, Rome, NY (US)

(21) Appl. No.: 14/178,226

(22) Filed: Feb. 11, 2014

(51) Int. Cl. G09F 19/00; G09F 3/12; G09F 3/04

(52) U.S. Cl. CPC G09F 19/00; G09F 3/04; G09F 3/12

(57) ABSTRACT

A method and apparatus for fashioning a posted sign and mounting the sign around a support structure is disclosed. A roll, including a spool and a span of flexible sheet material wound around the spool, is provided. The sheet material contains a posted notice that repeats a multiplicity of times along the span. The sheet material is drawn from the spool to a length sufficient to extend around the support structure. The notice repeats a plurality of times along the length. The length is separated from the span to produce the posted sign. The sign is mounted in a mounted position around the support structure, such that the notice repeats a plurality of times around the structure. In one case, the ends of the sign overlap in the mounted position, and the sign is mounted using a single nail or screw that pierces the ends and penetrates the support structure.

### BACKGROUND OF THE INVENTION

1. Field of Invention

The present invention relates generally to posted signs, and more particularly to apparatus and methods for fashioning and mounting a different type of posted sign.

2. Background Art

Generally, a posted sign is designed to keep the public away from private property that an owner wishes to reserve for his or her exclusive use. More specifically, a posted sign provides notice to the public about restrictions and/or hazards on the owner's land or in a defined area. Restrictions may include an outright ban on entering the property (e.g., “No Trespassing”) or a prohibition on specific activities (e.g., “No Hunting, Fishing or Trapping”). A posted sign may also advise caution about a particular hazard, such as falling, drowning, blasting, an abandoned mine, toxic waste, etc. (e.g., “Caution Blasting”). On the other hand, a posted sign may instruct a would-be trespasser to ask permission before entering the property, or may specifically indicate that only hikers are welcome. Further, a posted sign may warn of consequences for disobeying the posted notice (e.g., “Violators will be Prosecuted to the Fullest Extent of the Law”). Lastly, a posted sign should display the name and address of the land owner, to help substantiate the posting and facilitate communication with the owner if necessary.

The effectiveness of posted signs depends on their visibility. Obviously, the sign and its message must be large enough for onlookers to see the sign and read its message from a reasonable distance. But, visibility is also measured by whether the sign and its message can be seen and read from different approach directions (or angles). Many posted signs are flat with limited surface area, and therefore provide a limited field of view (e.g., 90 degrees). They can easily be missed and are nearly impossible to see from the owner's side of the boundary. The following U.S. patent documents disclose such signs: 2013/0240703 to Bergmann; U.S. Pat. No. 8,112,924 to Longobardo; 2010/0154263 to Riverio; and U.S. Pat. No. 6,186,454 to Olsen. U.S. Pat. No. 3,486,262 to Gregoire proposes to increase the field of view by providing a pair of message surfaces. However, the optimum solution would be to provide message visibility over 360 degrees. Visibility also requires sufficient frequency of posted signs along the perimeter of the property and in places where people are expected to approach or pass (e.g., roads, pathways, riverbanks, etc.). For example, 150 or more signs may be needed for a 50-acre parcel if a sign is mounted every 25-50 feet around the perimeter of the parcel. Achieving this level of visibility is a challenging and expensive effort by the land owner, especially if he or she is using conventional posted signs mounted on wooden backers. The number of signs, backers, fasteners, and tools required to be carried into the field contributes to this challenge and expense.

Posted signs are typically made of plastic, Tyvek®, coated paper or cardboard, and sometimes wood or aluminum. The signs may be fastened directly to a support structure, such as a fence, post, pole or tree. However, if the sign material is plastic, Tyvek®, or coated paper or cardboard, the sign may be first mounted to a backer (e.g., plywood), which is then mounted to the support structure. A backer may be desired to increase the durability of the mounted sign. If backers are used, the land owner is usually burdened with the task of making the backers, e.g., by sawing up sheets of plywood. Then, the owner must fasten a sign to each backer using staples, tacks or nails. The backers with signs are then carried or otherwise transported into the field for mounting on trees or other support structures. As mentioned, a large number of these signs may be needed to properly post a parcel of land. Thus, it is easy to see how the posting of property can become a time consuming, labor intensive, cumbersome, and expensive process. A long felt, but unfulfilled need has existed to simplify this process.

Posted signs are mounted on support structures using various fastening means, such as brackets, U-bolts, U-shaped hangers or clips, nuts and bolts, screws, nails, straps, cord, etc. Examples of such fastening means are shown in the above-mentioned patent documents. The type of fastener usually depends on the type of support structure. Trees, in many cases, are the most common structure for supporting posted signs in rural areas. A common fastener used to fasten a posted sign to a tree is a galvanized nail or concrete screw (or anchor). Usually, two or more such nails or screws are driven through the backer board and into the tree to securely mount the sign. Nails or screws can injure or kill a tree and may disqualify the tree from being harvested by loggers or firewood cutters. Thus, it would be desirable to eliminate or at least minimize the use of nails or screws to mount posted signs to trees.

When a posted sign is mounted to a live tree, little consideration is given to the fact that the tree continues to grow, and the trunk of the tree expands with this growth. Trunk expansion sometimes causes nails or screws to work their way out of the trunk or be swallowed up by the trunk. In addition, trunk expansion can cause nails or screws to be ripped from the sign. In any such case, the integrity of the mounting is compromised and eventually the posted sign will fall from the tree. A posted sign must remain in place to be effective. U.S. Pat. No. 8,112,924 to Longobardo recognizes the problem of hanging a posted sign on a growing tree. However, Longobardo's approach utilizes four nails or screws that penetrate the tree, and the expansion of the tree trunk is accommodated by a sliding anchor-on-track system. Thus, a need still exists for a more durably mounted posted sign and one that can withstand the reasonable growth of a tree.

The present invention is intended to overcome the problems of conventional posted signs, and fulfill the aforementioned needs, by employing a posted sign made of flexible sheet material that wraps around a support structure. A number of U.S. patents have proposed flexible banners, pennants or signs containing messages and/or ornamentation, designed to wrap around a structure such as a pole, column or tree. For example, see the following patent documents: U.S. Pat. No. 8,539,703 to DeMarco; U.S. Pub. Appl. 2013/0022781 to Allen; PCT Pub. Appl. WO 2010/031156 to Patton; U.S. Pub. Appl. 2009/0139441 to Barone; U.S. Pat. No. 6,775,937 to Ruana; U.S. Pat. No. 6,363,644 to Frost; U.S. Pat. No. 5,776,558 to Wotton; U.S. Pat. No. 4,837,959 to Celico; U.S. Pat. No. 5,383,296 to Vecchione; U.S. Pat. No. 1,096,580 to Webb. The published U.S. application to Barone proposes two or more repetitive displays on a banner wrapped around a tree. The examples in these patent documents do not address the problem of mounting such banners, pennants and signs to a growing and expanding tree trunk, and they are not concerned with posted signs and their requirements.

### OBJECTS AND SUMMARY OF THE INVENTION

It is therefore an object of the present invention to overcome the problems associated with conventional posted signs and to fulfill the aforementioned needs.

It is another object of the present invention to provide a posted sign having high visibility and visibility over a wide range of approach angles.

It is a further object of the present invention to provide a posted sign that is customized for a perimeter of a particular support structure and to provide a method and apparatus for fashioning such a customized posted sign.

It is yet another object of the present invention to simplify the process of fashioning and mounting posted signs, to make it easier for a landowner to post a parcel of land with a sufficiently high enough frequency.

It is yet a further object of the present invention to provide a more durable mounting scheme for a posted sign, especially when mounted to a growing and expanding tree trunk.

It is still another object of the present invention to reduce injury to trees caused by mounting posted signs to the trees, by minimizing the number of nails or screws needed for mounting or by eliminating the need for such nails or screws.

It is still a further object of the present invention to provide a low-cost posted sign and posting process.

These and other objects are attained in accordance with the present invention, wherein there is provided a method of fashioning a posted sign and mounting the posted sign around a perimeter of an upright support structure. The method comprises several steps. First, a roll is provided, which includes a spool and a span of flexible sheet material wound around the spool. The sheet material has a printed side containing a posted notice that repeats a multiplicity of times along the span. In some implementations, the posted notice contains a message and an owner-information area adjacent to the message. Second, the flexible sheet material is drawn from the spool to a length sufficient to extend around the perimeter of the upright support structure. The posted notice repeats a plurality of times along the length. Third, the length of the flexible sheet material is separated from the span to produce the posted sign. The produced sign has first and second opposing ends. Fourth, the posted sign is mounted in a mounted position around the perimeter of the upright support structure, such that the posted notice is displayed and repeated a plurality of times around the perimeter. In one implementation, the first and second opposing ends of the posted sign are overlapped in the mounted position and the sign is mounted to the upright structure using a single nail or screw. The nail or screw pierces the overlapping ends of the sign and penetrates the support structure.

In many cases, the upright support structure may be a living tree that has a tree trunk with an expandable perimeter (e.g., expansion due to growth). In one embodiment, the posted sign is made of a linear-tear material and the sign is mounted to the tree trunk with a “tearing fastener,” such as a nail or screw. The tearing fastener pierces the posted sign (e.g., the overlapping ends of the posted sign) in the mounted position. The fastener tears the linear-tear material of the sign as the perimeter of the tree trunk expands, such that the mounted position of the sign naturally adjusts to tree trunk expansion. In another embodiment, the posted sign is made of any suitable flexible sheet material, including but not limited to linear-tear material. In this other embodiment, the posted sign is mounted to the tree trunk with a fastener having an elastic cord. The elastic cord has first and second opposing ends and means at each end for engaging the first and second ends of the posted sign, respectively. In the mounted position, the elastic cord is attached to the ends of the sign by the engaging means. As the tree trunk expands, the elastic cord correspondingly expands. Thus, the mounted position of the sign naturally adjusts to tree trunk expansion. In a further embodiment, the posted sign may again be made of any suitable flexible sheet material and may be mounted to the tree trunk using a compressible band fastener. In this embodiment, the compressible band encircles the first and second ends of the posted sign (in the mounted position). Upon compression of the band, the band holds the ends of the sign in a secure but yielding manner. In this embodiment, the mounted position of the posted sign naturally adjusts to tree trunk expansion by a corresponding yielding of the ends of the sign.

A kit, to be carried into the field, for fashioning and mounting a plurality of posted signs is also part of the present invention. The kit enables the user to customize each posted sign for a perimeter of a different upright support structure. The kit comprises a roll of flexible sheet material and a plurality of fasteners. The roll includes a spool and a span of flexible sheet material wound around the spool. The sheet material has a printed side containing a posted notice that repeats a multiplicity of times along the span. In some embodiments, the posted notice may contain both a message and an owner-information area. The owner-information area may be blank to allow an owner to manually enter name and address information, or the area may be pre-printed with the owner's information. The spool is adapted to facilitate the drawing out of different lengths of the sheet material, such that they can be separated from the span to fashion one of the posted signs. Each of the lengths contains the posted notice repeated a plurality of times, and each is customized for a perimeter of a different upright support structure. Each of the fasteners is adapted to mount one of the posted signs in a mounted position around the perimeter of the upright structure for which the sign is customized. In this mounted position, the posted notice is displayed and repeated a plurality of times around the perimeter. The fasteners of the kit can be, for example, tearing fasteners, elastic cord fasteners, compressible band fasteners, or a combination of different types of fasteners. In the case where a tearing fastener is used, the flexible sheet material of the roll may (but does not have to) be a linear-tear material.

In at least one embodiment, the present invention may merely consist of the above-described roll, including a spool and a span of flexible sheet material wound around the spool.

A tree trunk of a living tree may expand due to growth of the tree or as a result of seasonal or environmental factors. In one embodiment of the present invention, there is provided an apparatus for posting a notice on a tree trunk of a living tree. The apparatus comprises a piece of flexible sheet material and a fastener. The piece of flexible sheet material has an elongated dimension terminating at first and second opposing ends and has a printed side. The printed side contains a posted notice that repeats a plurality of times along the elongated dimension. The fastener is adapted to mount the piece of flexible sheet material to the tree trunk in a mounted position. The fastener accomplishes this by engaging the piece at each of its ends. In the mounted position, the elongated dimension of the piece is oriented substantially around the expandable perimeter of the tree trunk and the posted notice is displayed and repeated a plurality of times around the perimeter. The engagement of the fastener with the piece of flexible sheet material is of such a nature that it allows the mounted position of the piece to naturally adjust to an expansion of the tree trunk.

### BRIEF DESCRIPTION OF THE DRAWING

Further objects of the present invention will become apparent from the following description of preferred embodiments, with reference to the accompanying drawing, in which:

FIG. 1 is a slight perspective view of one embodiment of the present invention, showing a roll, including a spool and a span of flexible sheet material wound around the spool, and a posted notice repeated a number of times on the span;

FIGS. 2A and 2B are perspective views showing alternative embodiments of the spool used to hold the span of flexible sheet material;

FIG. 3 is a slight perspective view of the roll in FIG. 1, but, here, illustrating a step of separating a length of the flexible sheet material from the span, using a scissors;

FIG. 4 is a front elevation view of a length of the flexible sheet material separated from the roll in FIG. 3 and constituting a posted sign with an elongated dimension D;

FIGS. 5A thru 5I are a series of views showing different types of fastener's used in practicing various embodiments of the present invention;

FIGS. 6A thru 6D are a series of diagrammatic views, each illustrating a posted sign of the present invention mounted on a tree with a different type of fastener and with no fastener in one case;

FIGS. 7A thru 7C are a series of diagrammatic views illustrating examples of the expanding function of the present invention in response to a growing tree, the expanded position being shown in solid lines; and

FIG. 8 is a flow diagram outlining the steps of a preferred method of the present invention.

### DETAILED DESCRIPTION OF THE PREFERRED EMBODIMENT

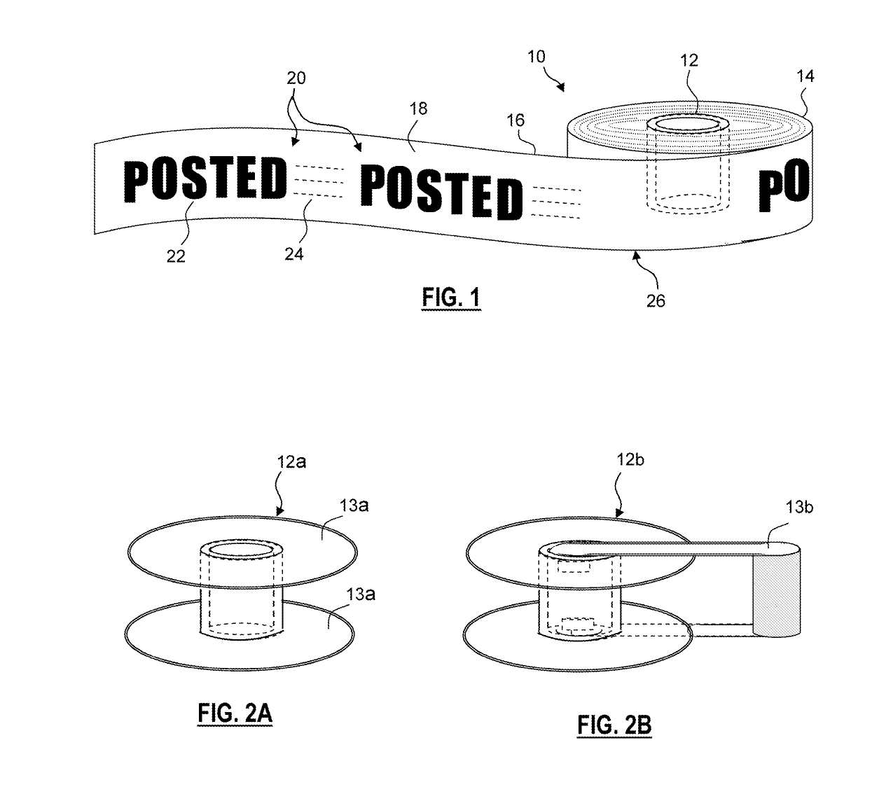

Referring to FIG. 1, there is shown an exemplary embodiment of a roll 10 for fashioning a plurality of posted signs (FIG. 4). Roll 10 includes a spool 12 and a span 14 of flexible sheet material 16 wound around the spool. Sheet material 16 has a printed side 18 containing a posted notice 20 that repeats a multiplicity of times along span 14. Posted notice 20 contains a message 22 and an owner-information area 24 adjacent to message 22. Spool 12 is adapted to facilitate the drawing out of different lengths of sheet material 16. A particular length 26 is shown in FIG. 1. Spool 12 has a hollow cylindrical shape with open, opposing ends (FIG. 1), which allow a user to grasp roll 10 with the fingers and draw out each length. Other examples of spool 12 are shown in FIGS. 2A and 2B. In FIG. 2A, a spool 12a has the same hollow cylindrical member as spool 12, but further includes a flange 13a at each open end of the cylindrical member. Each flange 13a contains a hole at its center, which communicates directly with the open ends of the cylindrical member. Flanges 13a may further assist a user in handling roll 10 and in drawing out lengths of sheet material 16. In FIG. 2B, a spool 12b is the same as spool 12a, except that it further includes a handle 13b. Handle 13b is rotatably mounted to the cylindrical member by means of bushings integrally connected to handle 13b, which project into the cylindrical member through the open ends, as shown in FIG. 2B. Handle 13b may further facilitate the use of roll 10.

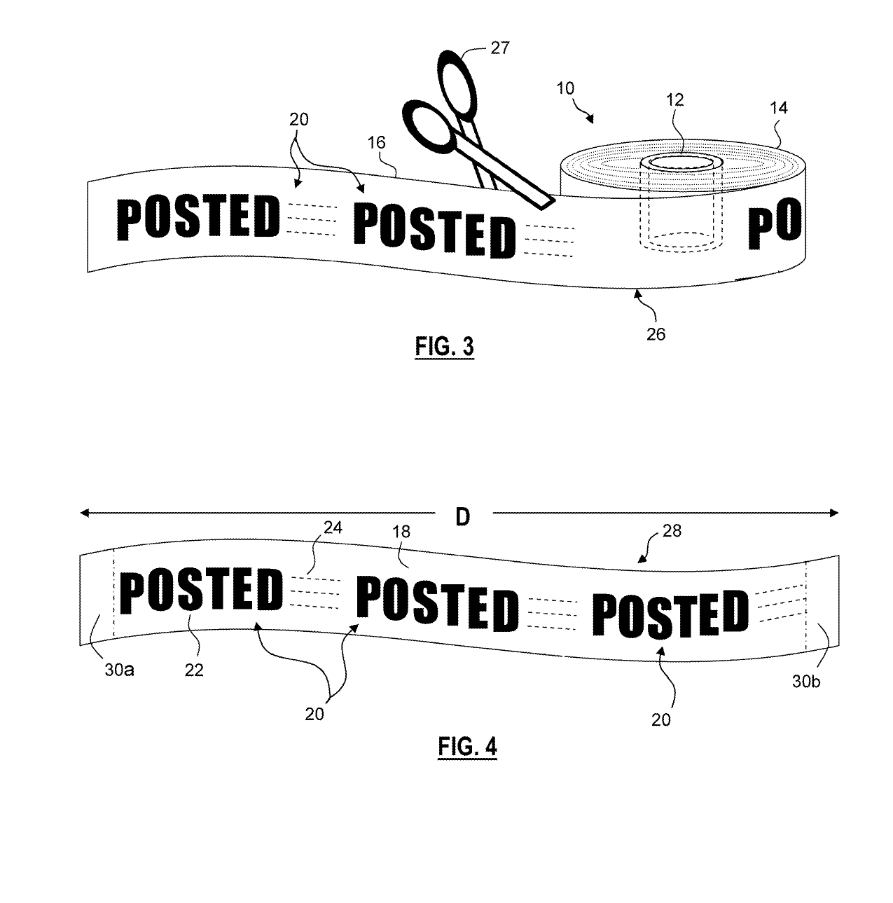

Referring now to FIGS. 3 and 4, length 26 of flexible sheet material 16 is drawn out from spool 12 and separated (e.g., cut) from span 14 to fashion a particular posted sign 28 (FIG. 4). An advantage of this embodiment is that posted sign 28 can be customized for a perimeter (e.g., sized to reach around the perimeter) of a particular upright structure intended to support sign 28. Different sized lengths are drawn from spool 12 to meet the dimensions and configurations of different upright support structures. This can be done, for example, by visual inspection and comparison or by wrapping the length (such as length 26) around the upright structure before separating it from span 14. Due to the size of typical upright structures and the print size of posted notice 20, notice 20 repeats a plurality of times along length 26. Typically, notice 20 may be repeated 3 to 4 (or more) times along length 26 (or posted sign 28). As shown in FIG. 4, notice 20 is repeated three times along posted sign 28.

Posted sign 28 is fashioned by separating length 26 from span 14. Separation is typically accomplished by cutting the length with a scissors 27 (FIG. 3), letter opener or slitter (with steel blade), or other suitable tool. Alternatively, span 14 may contain transversely-disposed perforated lines at periodic intervals, such that lengths 26 can be manually torn from span 14. As shown in FIG. 4, posted sign 28 has an elongated dimension D terminating at opposing ends 30a and 30b. Ends 30a and 30b are defined as including the short edges of sign 28 and a useful segment inward from the edges, as shown in FIG. 4. Typically, sign 28 has one printed side—printed side 18—and three or four posted notices 20 on printed side 18 (three are shown in FIG. 4). With three or four repetitions of notice 20, the notice is visible over 360 degrees (or at any approach angle) when sign 28 is mounted. As indicated, each notice 20 may comprise message 22 and owner-information area 24. Message 22 may be any suitable message alerting and warning the public about prohibitions, restrictions and/or hazards concerning the owner's land. Without limiting the scope of the invention, some examples are: “No Trespassing,” “Keep Out,” “No Hunting, Fishing or Trapping,” “No Hunting or Trapping; Hiking Permitted,” “Caution Blasting,” “Contact Owner Before Entering,” or “Violators Will Be Prosecuted To The Fullest Extent Of The Law.” Owner-information area 24 is provided to display at least the name and address of the land owner. This helps establish and substantiate the authority for the posted sign and its message. It also facilitates communication with the owner if necessary. Area 24 may be blank to allow an owner to manually enter name and address information or it may be pre-printed with the owner's information. In some embodiments, it may not be necessary to have an owner-information area repeated as part of every notice 20 on the sign. But, it is desirable to have at least one owner-info area on each sign.

Preferably, posted notice 20 should be printed with alphanumeric characters that are at least 3.5 inches high to ensure adequate visibility. Typically, the height of posted sign 28 should be at least 4 inches. Thus, span 14 (FIG. 3) should be at least 4 inches wide (or high). Span 14 should also be at least 100 feet long to produce a fair number of posted signs. For example, if the upright support structures are trees, the typical length D (FIG. 4) of a posted sign would be about 50 inches; thus, a 100-foot span would produce 24 signs. In some cases, span 14 may be 1000 feet long, depending on the type of sheet material used. If posted sign 28 has a height of 4 inches and a length of 50 inches, it would have an area of 200 square inches, which exceeds those states' regulations requiring 144 square inches.

Flexible sheet material 16 (and thus posted sign 28) is preferably made of a spunbonded olefin material with high-density polyethylene fibers. DuPont of Wilmington, Del., manufactures and sells such material under the brand, Tyvek®. Alternative materials for sheet material 16 may include: linear-tear multi-layered or laminated flexible packaging material, polyethylene, poly-laminate paper, or even thin, flexible sheets of aluminum or other metal. Sheet material 16 may be any desired color, but preferably a conspicuous color, such as yellow, orange, red, blue, and the like.

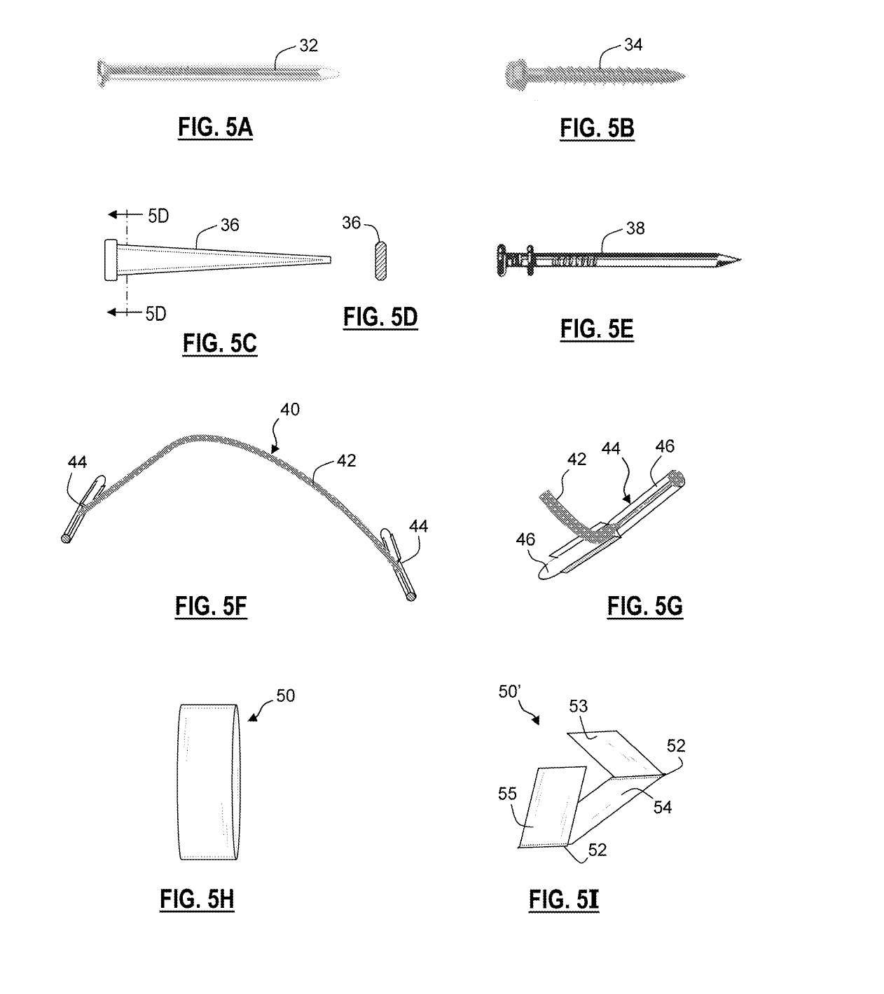

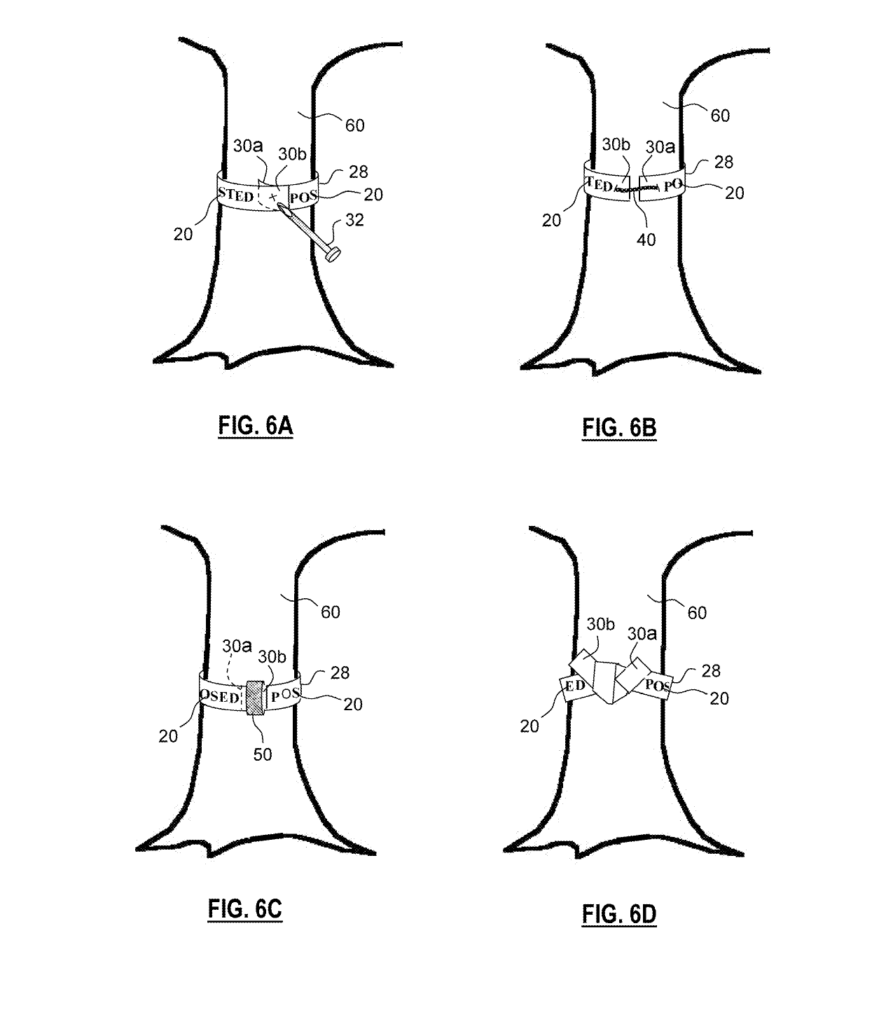

Referring now to FIGS. 5A thru 5E, there are shown various types of fastener's used in mounting posted sign 28 to an upright support structure, such as a tree. The fasteners in FIGS. 5A thru 5E are intended to penetrate sign 28 and the support structure to fix sign 28 in a mounted position. FIG. 5A shows a common nail 32 made of dipped or coated steel for wood or concrete. Nail 32 may have a nail head diameter of at least 0.25 inches and a shank length of between about 1.5 to about 3 inches. FIG. 5 B shows a concrete screw or anchor 34, such as a Tapcon® concrete screw or anchor. Anchor 34 has dimensions similar to nail 32. FIG. 5C shows a hard (steel) cut masonry nail 36, such as supplied by Grip-Rite, Irving, Tex. Nail 36 may be 2.5 inches long. The shank of nail 36 has a substantially tapered and elongated cross-section, as shown in FIG. 5D. FIG. 5D is a cross-sectional view taken along line 5D-5D in FIG. 5C. Other types of square-cut nails may also be used, such as supplied by Tremont Nail, Mansfield, Mass. FIG. 5E shows a common duplex-head (or double-headed) nail 38 of similar dimensions to nail 32. As shown, nail 38 has a shank and two nail heads disposed along the shank and separated by a margin space. Fasteners 32, 34, 36 and 38 are driven through sign 28 (typically, through overlapping ends of sign 28) and into the support structure (wood, concrete or masonry) when mounting sign 28 (e.g., see FIG. 6A).

Referring now to FIGS. 5F and 5G, there is shown an elastic cord fastener 40, sometimes referred to as an elastic bungee string or cord with metal barbs (or “barbed elastic”). Fastener 40 includes an elastic cord 42 and metal barbs 44 at each end of cord 42. Cord 42 may be constructed of typical bungee cord (e.g., braided polyester) and barbs 44 may be made of nickel-plated steel or aluminum. In an alternative configuration, elastic cord fastener 40 may be equipped with meal resilient clips (like alligator clips) instead of bards. FIG. 5G shows a closer look of barb 44. It includes a clasp portion 46 that receives an end of cord 42 and is pinched or crimped around the end for a secure connection. Barb 44 further includes a piercing portion 48 having a thin pointed end for piercing a work piece or guiding the barb through a hole or eyelet in the work piece. Fastener 40 is used to mount postage sign 28 to an upright support structure by engaging the ends of sign 28 after the sign is wrapped around the support structure (e.g., see FIG. 6B). The engagement is accomplished by piercing the sign's ends with barbs 44 and pulling the barbs through the ends to anchor cord 42 to each end of the sign. In the configuration using clips, the clips are merely clipped onto the ends of sign 28 after the sign has been wrapped around the support structure.

Referring now to FIGS. 5H and 5I, there are shown two versions 50 and 50′, respectively, of a compressible metal band fastener. Fasteners 50 and 50′ are made of a compliant sheet metal, such as aluminum, tin, brass, steel or nickel-plated steel. Fastener 50 is in the form of a continuous band or sleeve, and is dimensioned to received and encircle the ends of sign 28. Fastener 50 can be compressed to a fixed position, where it imparts a clamping force on the ends of sign 28. Fastener 50 is used to mount sign 28 to an upright support structure by slipping the ends of sign 28 through fastener 50 in an overlapping fashion (e.g., see FIG. 6C). Fastener 50 is then compressed to clamp and hold the sign in place. Fastener 50′ is in the form of an elongated strip with two creases that facilitate the forming of two folds 52. Folds 52 divide the strip into three sections 53, 54 and 55. In the example shown in FIG. 5I, sections 53 and 55 are of equal lengths and the sum of those lengths equal the length of section 54. Fastener 50′ can be folded into a sleeve-like form and used like fastener 50, or it can be folded around the overlapping ends of sign 28 and compressed to hold the sign in a mounted position on a support.

Referring now to FIGS. 6A thru 6D, four different examples are shown of how sign 28 can be mounted to an upright support structure. FIGS. 6A thru 6C illustrate the use different types of fasteners and FIG. 6D illustrates a method without fasteners. In FIG. 6A, sign 28 is wrapped around the perimeter of an upright support structure 60, which, in this case, is a tree. Ends 30a and 30b of sign 28 are placed in an overlapping arrangement. Nail 32 (or anchor 34, square-cut nail 36, or duplex-head nail 38) is driven through the overlapping ends 30a, 30b and into tree 60, to hold sign 28 in a mounted position as shown in FIG. 6A. When using fasteners 32, 34 and 36, it is best not to drive the head up against sign 28 and tree 60, but rather let the head and shank project out a little to leave a small margin for tree growth. In the case of duplex-head nail 38, the head closest to the point of the nail (inner head) is also not driven up against sign 28 and tree 60. The other (outer) head of nail 38 facilitates the removal of the nail, especially if the inner head becomes embedded in tree 60.

In FIG. 6B, posted sign 28 is wrapped around the perimeter of the trunk of tree 60. Ends 30a and 30b of sign 28 are shown slightly spaced apart, but may be in an overlapping position. Elastic cord fastener 40 engages both ends 30a, 30b by means of metal barbs 44 (FIG. 5F) pushed through and anchoring the ends. The locations where barbs pierce through ends 30a, 30b are selected so that elastic cord 42 (FIG. 5F) is taut enough to hold sign 28 in a mounted position around tree 60. Elastic cord 42 does not actually have to be taut or stretched, but may have a little slack and still sufficiently hold sign 28 in place. In the alternative configuration using resilient clips, sign 28 is held in the mounted position by applying the clips to ends 30a, 30b at such locations as would enable elastic cord 42 to hold the sign in place. In many applications, the use of fastener 40 is preferred, because it does not cause marring or more serious injury to a tree (or other upright structure) during the mounting or removal of sign 28. If metal barbs are used, they are easily pushed through materials such as Tyvek® or laminated paper; however, a hole punch may be needed for some plastics or metal.

In FIG. 6C, posted sign 28 is wrapped around the perimeter of the trunk of tree 60. Ends 30a and 30b of sign 28 are in an overlapping position. Each end extends through compressible band 50 from opposite sides. Once in place, band 50 encircles overlapping ends 30a, 30b. Band 50 is compressed or pinched against ends 30a, 30b and remains there in a fixed position. As shown, sign 28 is held in a mounted position around tree 60 once band 50 is compressed. The compressed band 50 holds ends 30a, 30b in a secure but yielding manner, which means that if enough expansive force is applied to sign 28 by tree 60, ends 30a, 30b will begin to pull back out of band 50. Band 50 will slowly yield to the expansive force. The amount that ends 30a, 30b extend out of band 50 (i.e., selvage) should be sufficient enough to allow plenty of yielding before the ends come free of band 50. The use of fastener 50 (or 50′) is also desired if the goal is to minimized or eliminate injury to tree 60 or any other type of support structure.

In FIG. 6D, posted sign 28 is wrapped around the perimeter of the trunk of tree 60. A fastener is not used. Rather, ends 30a and 30b are tied into a double knot to hold sign 28 in a mounted position around tree 60. Other types of knots or a bow may also be suitable for mounting sign 28 to tree 60. In whatever knot or bow used, it may be desirable (in some applications) to leave some “play” in the knot or bow to allow sign 28 to adjust (e.g., expand) in response to an expanding perimeter of tree 60. This mounting approach also avoids damage to the support structure or tree. In all the mounted positions shown in FIGS. 6A thru 6D, the elongated dimension D (FIG. 4) of sign 28 is oriented horizontally and substantially around the perimeter of the trunk of tree 60. Further, posted notice 20 is displayed and repeated a plurality of times around the perimeter of tree 60. In another application, sign 28 may be mounted in a vertical orientation, e.g., hanging vertically down the side of a tree trunk, post or pole. In this latter application, the alphanumeric characters of the posted notice would be reoriented, so they are upright when sign 28 is positioned vertically.

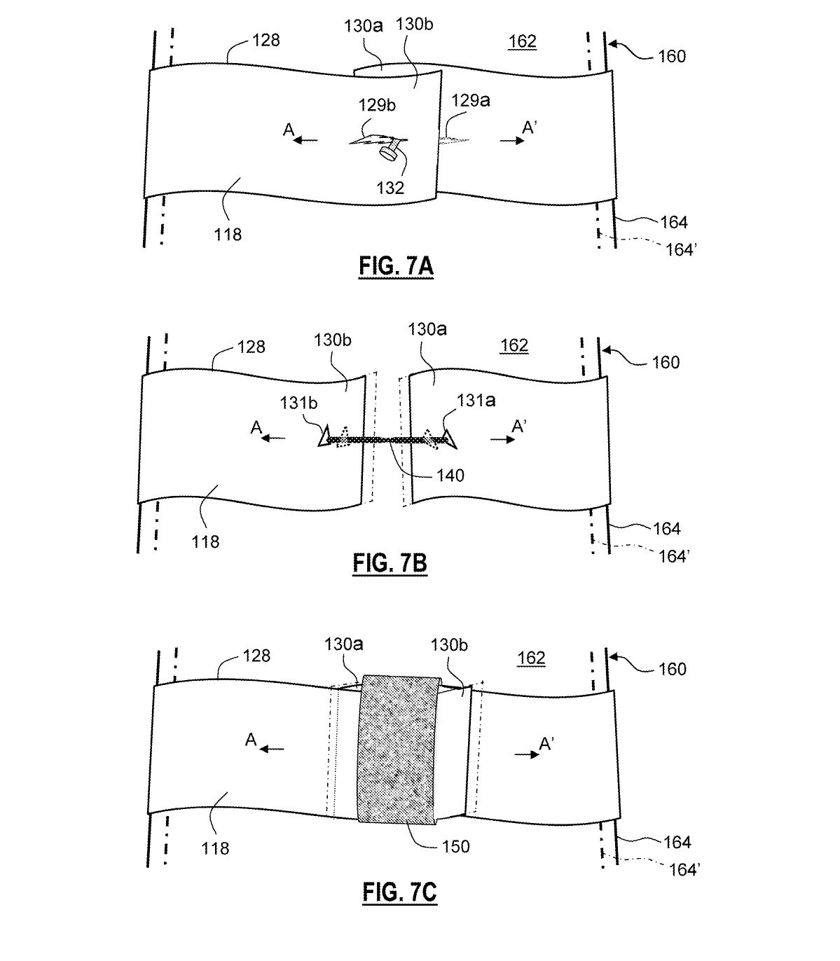

The adjusting function of some embodiments of the present invention will now be described with reference to FIGS. 7A-7C. In those cases where the upright support structure expands over time, such as when a tree grows, it would be advantageous to have an adaptable mounting arrangement for the posted sign—an arrangement where the mounted position adjusts naturally with the expansion. The embodiments shown in FIGS. 7A-7C provide such an adaptable arrangement. For instance, FIG. 7A shows a controlled tearing arrangement, FIG. 7B shows a stretching arrangement, and FIG. 7C shows a resistant sliding arrangement. In FIGS. 7A-7C, a tree 160 has a tree trunk 162 with an initial unexpanded perimeter 164′ and an expanded perimeter 164. The trunk's perimeter expands due to normal tree growth, seasonable variations, and/or environmental factors. A posted sign 128 has opposing ends 130a and 130b and a printed side 118 facing away from trunk 162. A posted notice (not shown) is printed on printed side 118 and repeated a plurality of times between ends 130a and 130b. FIGS. 7A-7C show posted sign 128 mounted in a mounted position around trunk 162. The solid lines of sign 128 represent an adjusted mounted position, which resulted from the tree trunk expanding from perimeter 164′ to perimeter 164. Arrows A. A′ designate the direction of movement of sign 128 during the adjustment.

In the embodiment of FIG. 7A, posted sign 128 is made of a “linear-tear material.” As used herein, “linear-tear material” is any sheet material that tears against a fastener in a substantially controlled manner and substantially along a desired direction, such that the tear does not substantially propagate randomly or in multiple directions. “Linear-tear material” does not have to be specifically engineered to exhibit the aforementioned property, but may be any sheet material exhibiting the property. For example, spunbonded olefin with high-density polyethylene fibers (e.g., Tyvek®) is considered a “linear-tear material” for the purposes of the present invention. The term “linear-tear material” also includes specifically engineered materials, such as monolayer, multilayer or multi-laminate sheets that exhibit the aforementioned property. For example, see the linear-tear materials in U.S. Pat. No. 6,479,137 to Joyner et al. (Exxon Mobil Oil Corp.), incorporated herein by reference. Similar linear-tear materials are supplied by Ampac, Cincinnati, Ohio Another type of specifically engineered linear-tear material is a suitable flexible sheet material containing perforations along a desired tear-direction and for a desired length, to promote a controlled linear tear of the material. A fastener used to tear a piece of linear-tear material is sometimes referred to herein as a “tearing fastener.”

In FIG. 7A, sign 128 is mounted to tree trunk 162 with a common nail 132 piercing both overlapping ends 130a, 130b and penetrating trunk 162. The dash-dot lines of trunk 162 represent the initial (unexpanded) perimeter 164′ (i.e., when sign 128 was first mounted to trunk 162). The corresponding solid lines of trunk 162 represent expanded perimeter 164. As shown in FIG. 7A (and by arrows A, A′), the mounted position of sign 128 naturally adjusts to expanding perimeter 164 by a tearing of sign 128 against nail 132. Stationary nail 132 has caused tears 129a and 129b in ends 130a and 130b, respectively. As shown, tears 129a and 129b are substantially linear along the elongated dimension of sign 128. Thus, sign 128 maintains its structural integrity and remains in the mounted position, except only adjusted to accommodate trunk expansion. The phrase, “naturally adjusted,” means adjusted in direct and natural response to the expansion of the perimeter of trunk 162 or other support structure. Ideally, the linear tearing of sign 128 directly corresponds to the expansion of the perimeter of tree trunk 162. Square-cut nail 36 (FIGS. 5C & 5D) may be best suited to create linear tears 129a, 129b, because of its elongated and slightly tapered cross-section (FIG. 5I)), provided that its elongated dimension is aligned with the elongated dimension of sign 128.

In FIG. 7B, sign 128 is mounted to tree trunk 162 with an elastic cord fastener 140 having metal barbs. The barbs (not shown) are pushed through ends 130a and 130b, respectively, of sign 128, creating openings 131a and 131b. The dash-dot lines of trunk 162 represent initial perimeter 164′ and the corresponding solid lines represent expanded perimeter 164. The dash-dot lines of sign 128 represent the initial position of sign 128 and the corresponding solid lines represent the adjusted position. Fastener 140 stretches in the directions of arrows A, A′, allowing sign 128 to move in those directions and adjust with expanding perimeter 164. Thus, the mounted position of sign 128, as shown in FIG. 7B, naturally adjusts to an expansion of tree trunk 162, by a corresponding stretch or expansion of elastic cord fastener 140. The elastic nature of fastener 140 should allow for several years of tree growth.

In FIG. 7C, sign 128 is mounted to tree trunk 162 with a compressible band fastener 150. In the mounted position, ends 130a, 130b of sign 128 extend through fastener 150 from opposite sides and are held in an overlapping fixed position by a clamping force imposed by fastener 150. As now understood by the dash-dot and solid line convention previously established, FIG. 7C shows that ends 130a, 130b begin to pull from fastener 150, in the directions of arrows A, A′, as the tree trunk perimeter expands from initial perimeter 164′ to expanded perimeter 164. The force imposed by trunk expansion exceeds the clamping force of fastener 150, causing ends 130a, 130b to yield with the expansion. Thus, the mounted position of sign 128 naturally adjusts to the expanding perimeter of trunk 162.

Another aspect of the present invention is a kit, to be carried into the field, for fashioning and mounting posted signs. In one embodiment, the kit may comprise the items shown in FIGS. 3, 5A-5C, 5E-5F and 5H-5I. That is, the kit may comprise roll 10, scissor 27 (or a letter opener or slitter), and one or more types of fasteners 32, 34, 36, 38, 40, 50 and/or 50′. A number of fasteners are included in the kit, and the number may depend on the length of sheet material on roll 10. For example, if roll 10 contains 100 feet of sheet material, 24 or 25 fasteners may be included in the kit. Additional tools may be included in the kit depending on the type or types of fasteners provided in the kit. For example, if nails are provided, a hammer may be included.

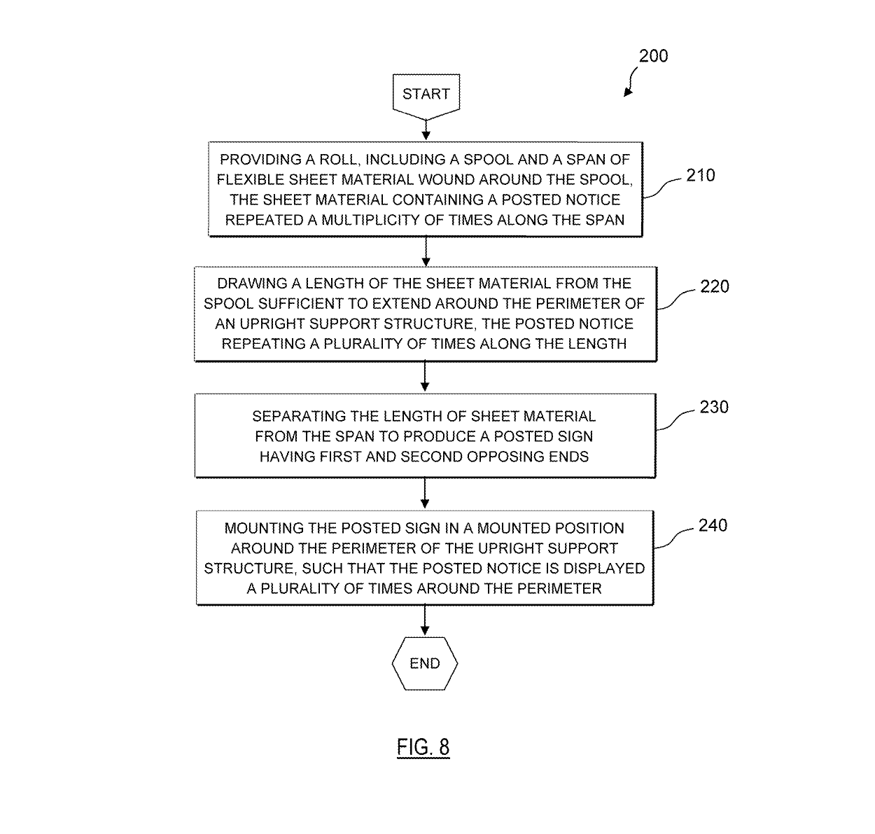

Referring now to FIG. 8, there is shown a flow diagram outlining a method 200 of the present invention. Method 200 is but one example, and the present invention is not limited to this example. Method 200 involves fashioning a posted sign and mounting the posted sign around a perimeter of an upright support structure. A first step 210 involves providing a roll that includes a spool and a span of flexible sheet material wound around the spool. The sheet material has a printed side containing a posted notice that repeats a multiplicity of times along the span. A second step 220 involves drawing a length of the sheet material from the spool sufficient to extend around the perimeter of the upright support structure. The posted notice repeats a plurality of times along the length. A third step 230 involves separating the length of sheet material from the span to produce a posted sign having first and second opposing ends. A fourth step 240 involves mounting the posted sign in a mounted position around the perimeter of the support structure, such that the posted notice is displayed and repeated a plurality of times around the perimeter. Of course, step 240 may include mounting the posted sign using any one of the fasteners earlier described and shown in FIGS. 5A-5I.

The posted sign of the present invention provides 360 degrees of visibility of a repeatedly displayed posted notice. Thus, a landowner's guests and potential trespassers are able to see a property boundary no matter what angle they are approaching. This is an advantage over conventional flat signs, which when mounted against one side of a tree have visibility limited to the roadside or neighboring properties. The posted sign of the present invention also has the advantage that it is adaptable to an expandable support structure, such as a growing tree. The posted sign of the present invention has a further advantage of being easily fashioned and mounted in the field. It is also inexpensive compared to many conventional posted signs.

While the preferred embodiments of the invention have been particularly described in the specification and illustrated in the drawing, it should be understood that the invention is not so limited. Many modifications, equivalents and adaptations of the invention will become apparent to those skilled in the art without departing from the spirit and scope of the invention, as defined in the appended claims.

What I claim is:

1. A roll for fashioning a plurality of posted signs each customized for a perimeter of a different upright support structure, comprising:
a spool; and
a span of flexible sheet material wound around the spool, the sheet material having a printed side containing a posted notice that repeats a multiplicity of times along the span,
the spool being adapted to facilitate the drawing out of different lengths of the sheet material, such that each of the lengths can be separated from the span to fashion one of the plurality of posted signs, each of the lengths being customized for a perimeter of a different upright support structure and containing the posted notice repeated a plurality of times.

2. The roll of claim 1, wherein the posted notice contains a message and an owner-information area adjacent to the message.

3. The roll of claim 1, wherein the flexible sheet material of said span is a linear-tear sheet material.

4. An apparatus for posting a notice on a tree trunk of a living tree, the tree trunk being characterized by an expandable perimeter, said apparatus comprising:
(a) a piece of flexible sheet material, having (i) an elongated dimension terminating at first and second opposing ends, and (ii) a printed side containing a posted notice that repeats a plurality of times along the elongated dimension; and
(b) a fastener, adapted to mount said piece of flexible sheet material to the tree trunk in a mounted position, including by engaging said piece at each of the first and the second opposing ends, such that the elongated dimension of said piece is oriented substantially around the expandable perimeter of the tree trunk and the posted notice on the printed side of the piece is displayed and repeated a plurality of times around the perimeter,
the engagement of said fastener with the first and the second opposing ends of said piece allowing the mounted position of said piece to naturally′ adjust to an expansion of the perimeter of the tree trunk.

5. The apparatus of claim 4, wherein the posted notice contains a message and an owner-information area adjacent to the message.

6. The apparatus of claim 4, wherein the first opposing end of said piece of flexible sheet material contains a linear-tear material, said fastener being adapted to (i) engage the linear-tear material at the first opposing end and (ii) tear the linear-tear material along the elongated dimension of said piece as the perimeter of the tree trunk expands, whereby the mounted position of said piece naturally adjusts to an expansion of the tree trunk by a corresponding tearing of the linear-tear material.

7. The apparatus of claim 6, wherein the second opposing end of said piece of flexible sheet material contains a linear-tear material, said fastener being adapted to (0 engage the linear-tear material at the second opposing end and (ii) tear the linear-tear material at the second end along the elongated dimension of said piece as the perimeter of the tree trunk expands.

8. The apparatus of claim 4, wherein said piece of flexible sheet material is made of a linear-tear material, said fastener being adapted to tear the linear-tear material along the elongated dimension of said piece as the perimeter of the tree trunk expands, whereby the mounted position of said piece naturally adjusts to an expansion of the tree trunk by a corresponding tearing of the linear-tear material.

9. The apparatus of claim 8, wherein the first and the second opposing ends of said piece of flexible sheet material overlap each other in the mounted position, and wherein said fastener is a single nail or screw adapted to pierce the overlapping ends and penetrate the tree trunk, whereby, in the mounted position, the single nail or screw tears the linear-tear material of said piece as the perimeter of the tree trunk expands.

10. The apparatus of claim 9, wherein the single nail or screw is a nail having a shank with an elongated cross-section to facilitate the tearing of the linear-tear material of said piece.

11. The apparatus of claim 4, wherein said fastener includes an elastic cord having first and second opposing ends and means at each of the ends for engaging the first and the second opposing ends of said piece of flexible sheet material, respectively, in the mounted position, whereby the mounted position of said piece naturally adjusts to an expansion of the tree trunk by a corresponding expansion of the elastic cord.

12. The apparatus of claim 4, wherein the first and the second opposing ends of said piece of flexible sheet material overlap each other in the mounted position, and wherein said fastener includes a compressible band (i) dimensioned to encircle the overlapping ends of said piece in the mounted position and (ii) adapted to hold, upon compression of the band, the overlapping ends in a secure but yielding manner, whereby the mounted position of said piece naturally adjusts to an expansion of the tree trunk by a corresponding yielding of the overlapping ends.

13. A kit, to be carried into the field, for fashioning a plurality of posted signs each customized for a perimeter of a different upright support structure, said kit comprising:
a roll, including a spool and a span of flexible sheet material wound around the spool, the sheet material having a printed side containing a posted notice that repeats a multiplicity of times along the span,
the spool being adapted to facilitate the drawing out of different lengths of the sheet material, such that each of the lengths can be separated from the span to fashion one of the plurality of posted signs, each of the lengths being customized for a perimeter of a different upright support structure and containing the posted notice repeated a plurality of times; and
a plurality of fasteners each adapted to mount one of the plurality of posted signs around the perimeter of the upright structure for which the sign is customized, such that the posted notice is displayed and repeated a plurality of times around the perimeter.

14. The kit of claim 13, wherein the posted notice contains a message and an owner-information area adjacent to the message.

15. The kit of claim 13, wherein:
(a) one of the different upright support structures is a tree trunk of a living tree characterized by an expandable perimeter;
(b) the flexible sheet material of the span is a linear-tear material and the plurality of posted signs are fashioned from the linear-tear material, the plurality of posted signs including a first posted sign customized for the perimeter of the tree trunk; and
(c) one of the plurality of fasteners is a tearing fastener, adapted to (i) mount the first posted sign in a mounted position around the expandable perimeter of the tree trunk and (ii) tear the linear-tear material of the first posted sign as the perimeter of the tree trunk expands, whereby the mounted position of the first posted sign naturally adjusts to an expansion of the tree trunk by a corresponding tearing of the linear-tear material.

16. The kit of claim 15, wherein the tearing fastener is a nail or screw, which, when used to mount the one posted sign, pierces the one posted sign and penetrates the tree trunk.

17. The kit of claim 13, wherein:
(a) one of the different upright support structures is a tree trunk of a living tree characterized by an expandable perimeter;
(b) the plurality of posted signs includes a first posted sign customized for the perimeter of the tree trunk, the first posted sign having first and second opposing ends; and
(c) the plurality of fasteners includes a first fastener having an elastic cord with first and second opposing ends and means at each of the ends for engaging, in the mounted position, the first and the second opposing ends of the first posted sign, respectively, whereby the mounted position of the first posted sign naturally adjusts to an expansion of the tree trunk by a corresponding expansion of the elastic cord.

18. The kit of claim 13, wherein:
(a) one of the different upright support structures is a tree trunk of a living tree characterized by an expandable perimeter;
(b) the plurality of posted signs includes a first posted sign customized for the perimeter of the tree trunk, the first posted sign having first and second opposing ends that overlap each other in the mounted position; and
(c) the plurality of fasteners includes a compressible band, the compressible band being (i) dimensioned to encircle the overlapping ends of the first posted sign in the mounted position and (ii) adapted to hold, upon compression of the hand, the overlapping ends in a secure but yielding manner, whereby the mounted position of the first posted sign naturally adjusts to an expansion of the tree trunk by a corresponding yielding of the overlapping ends.

19. A method of fashioning a posted sign and mounting the posted sign around a perimeter of an upright support structure, said method comprising the steps of:
(a) providing a roll, including a spool and a span of flexible sheet material wound around the spool, the sheet material having a printed side containing a posted notice that repeats a multiplicity of times along the span;
(b) drawing from the spool a length of the flexible sheet material sufficient to extend around the perimeter of the upright support structure, the posted notice repeating a plurality of times along the length;
(c) separating the length of flexible sheet material from the span to produce the posted sign, the posted sign having first and second opposing ends; and
(d) mounting the posted sign in a mounted position substantially around the perimeter of the upright support structure, such that the posted notice is displayed and repeated a plurality of times around the perimeter.

20. The method of claim 19, wherein the first and the second opposing ends of the posted sign overlap each other in the mounted position, and wherein step (d) is performed with a single nail or screw piercing the overlapping ends of the posted sign and penetrating the upright support structure.

21. The method of claim 19, wherein the upright support structure is a tree trunk of a living tree characterized by an expandable perimeter and the posted sign is made of a linear-tear material, and wherein step (d) is performed using a tearing fastener that pierces the posted sign and tears the linear-tear material of the sign as the perimeter of the tree trunk expands, whereby the mounted position of the posted sign naturally adjusts to an expansion of the tree trunk by a corresponding tearing of the linear-tear material.

22. The method of claim 19, wherein the upright support structure is a tree trunk of a living tree characterized by an expandable perimeter, and wherein step (d) is performed using a fastener having an elastic cord, the elastic cord having first and second opposing ends and means at each of the ends for engaging the first and the second opposing ends of the posted sign, respectively, whereby the mounted position of the posted sign naturally adjusts to an expansion of the tree trunk by a corresponding expansion of the elastic cord.

23. The method of claim 19, wherein the upright support structure is a tree trunk of a living tree characterized by an expandable perimeter, and wherein step (d) is performed using a compressible band that encircles the first and the second ends of the posted sign in the mounted position and, upon compression of the band, holds the ends in a secure but yielding manner, whereby the mounted position of the posted sign naturally adjusts to an expansion of the tree trunk by a corresponding yielding of the ends.
